(19) United States
(12) Patent Application Publication
(10) Pub. No.: US 2024/0025719 A1
(43) Pub. Date: Jan. 25, 2024

(54) Dual Needle Assembly for Sterile Filling of Containers

(71) Applicant: Northstar Medical Technologies, LLC, Beloit, WI (US)

(72) Inventors: Kent Toepfer, Sun Prairie, WI (US); Michael Allex, Verona, WI (US)

(73) Assignee: Northstar Medical Technologies, LLC, Beloit, WI (US)

(21) Appl. No.: 18/223,520

(22) Filed: Jul. 18, 2023

Related U.S. Application Data
(60) Provisional application No. 63/368,802, filed on Jul. 19, 2022.

(51) Int. Cl. B67C 3/26

(52) U.S. Cl. CPC B67C 3/26; B67C 2003/228

(57) ABSTRACT

A dual needle assembly comprising a housing comprising a first sterility filter, and a second sterility filter, a first needle for transporting a liquid comprising a first end coupled to the housing; and a second end extending from the housing, a second needle for transporting a stream of air comprising a third end coupled to the housing, and a fourth end extending from the housing. The first sterility filter is in-line with the first needle, such that the liquid transported via the first needle passes through the first sterility filter. The second sterility filter is in-line with the second needle, such that the stream of air transported via the second needle passes through the second sterility filter. The first sterility filter can be a fluid filter. The second sterility filter can be an air filter.

### CROSS-REFERENCE TO RELATED APPLICATION

This application claims the benefit of the filing date of U.S. provisional application Ser. No. 63/368,802, filed Jul. 19, 2022, entitled, “Dual Needle Assembly For Sterile Filling of Containers,” all of which is hereby incorporated by reference as if fully set forth herein.

### TECHNICAL FIELD

The present disclosure generally relates to sterile filling of a container and more particularly, to a dual needle assembly. Further, the present disclosure relates to a dual needle assembly comprising an air filter and a fluid filter.

### BACKGROUND

Using a vial sealed with a permeable cap such as an elastomeric cap or septa to maintain the sterility of a liquid in the vial is known. The elastomeric cap can allow a needle to pierce through it for adding or removing fluids to and/or from the vial. However, because the vial can be completely sealed due to the cap, the vial has a fixed volume. Thus, any addition of fluid can result in an increase in pressure within the vial; and any subtraction of fluid can result in a decrease in pressure within the vial.

To correct this problem, a second needle can be allowed to pierce the cap to permit ambient gas to flow either into the vial or out of the vial, depending on whether fluid is removed from or added to the vial, respectively. This ambient gas can normalize the internal vial pressure with ambient pressure or maintain a desired pressure. However, because the second needle can be open to the ambient atmosphere, it can entrain microbes and contaminate liquids in the vial.

Accordingly, a need exists for a dual needle assembly having a first sterility filter in-line with a first needle that transports a liquid to/from the vial and a second sterility filter in-line with a second needle, the second sterility filter sized to filter out harmful microbes and maintain sterility on the inside of the vial when adding or removing gas from the vial to maintain a pressure.

### BRIEF SUMMARY

Some aspects of this disclosure pertain to a dual needle assembly. The dual needle assembly includes a housing including a first sterility filter; and a second sterility filter; a first needle for transporting a first fluid, the first needle including a first end coupled to the housing; and a second end extending from the housing; a second needle for transporting a second fluid, the second needle including a third end coupled to the housing; and a fourth end extending from the housing, wherein a first flow path of the liquid passes through the first sterility filter, and wherein a second flow path of the stream of air passes through the second sterility filter.

Some aspects of this disclosure pertain to the first fluid being different than the second fluid.

Some aspects of this disclosure pertain to the first fluid including a liquid.

Some aspects of this disclosure pertain to the second fluid including a gas.

Some aspects of this disclosure pertain to the first sterility filter including a liquid filter, and the second sterility filter including an air filter.

Some aspects of this disclosure pertain to the housing including an upper portion; a lower portion coupled to the upper portion, wherein the first sterility filter is positioned between the upper portion and a first top surface of the lower portion, and wherein the upper portion is a fluid filter cap.

Some aspects of this disclosure pertain to the second sterility filter being positioned on a side of the lower portion of the housing.

Some aspects of this disclosure pertain to the lower portion including a fluid filter housing; an air filter housing; and the second sterility filter is positioned between the fluid filter housing and a second top surface of the air filter housing.

Some aspects of this disclosure pertain to the first needle having a first gauge, and the second needle having a second gauge equal to the first gauge.

Some aspects of this disclosure pertain to the first needle having a first gauge, and the second needle having a second gauge different than the first gauge.

Some aspects of this disclosure pertain to the first needle being is positioned adjacent to the second needle.

Some aspects of this disclosure pertain to the first needle being is positioned through a center opening of the second needle.

Some aspects of this disclosure pertain to the first needle having a first length, and the second needle having a second length equal to the first length.

Some aspects of this disclosure pertain to the first needle having a first length, and the second needle having a second length different than the first length.

Some aspects of this disclosure pertain to the second end of the first needle being tapered, and the fourth end of the second needle tapered.

Some aspects of this disclosure pertain to a dual needle assembly including a housing including an upper portion; and a lower portion coupled to the upper portion; a first needle for transporting a first fluid extending from the housing; and a second needle for transporting a second fluid extending from the housing; an air filter cover/guard; a needle guard surrounding the first needle and the second needle, and wherein the needle guard contacts at least a portion of the housing.

Some aspects of this disclosure pertain to the housing being surrounded by the needle housing.

Some aspects of this disclosure pertain to the needle guard including a lip designed to connect to the lower portion of the housing.

Some aspects of this disclosure pertain to the housing including a first sterility filter designed to filter a first fluid transported through the first needle; and the housing including a second sterility filter designed to filter a second fluid transported through the second needle.

Some aspects of this disclosure pertain to the first sterility filter is a liquid filter, and the second sterility filter is an air filter.

### BRIEF DESCRIPTION OF THE DRAWINGS

In the drawings forming a part of this disclosure:

FIG. 1A illustrates an isometric view of a dual needle assembly in accordance with an illustrated embodiment of the invention;

FIG. 1B illustrates an exploded view of the dual needle assembly of FIG. 1A;

FIG. 1C illustrates a cutaway view of the dual needle assembly of FIG. 1A;

FIG. 1D illustrates a top elevation view of the dual needle assembly of FIG. 1A;

FIG. 1E illustrates a front elevation view of the dual needle assembly of FIG. 1A;

FIG. 1F illustrates a bottom elevation view of the dual needle assembly of FIG. 1A;

FIG. 2A illustrates schematic view of a dual needle assembly under an alternative embodiment;

FIG. 2B illustrates a partial zoomed in schematic view of the dual needle assembly of FIG. 2A;

FIG. 3A illustrates an isometric view of a dual needle assembly in accordance with an alternative embodiment;

FIG. 3B illustrates an exploded view of the dual needle assembly of FIG. 3A;

FIG. 3C illustrates a cutaway view of the dual needle assembly of FIG. 3C;

FIG. 4A illustrates an isometric view of an assembly comprising the dual needle assembly of FIG. 1A-FIG. 1F and a needle housing in accordance with an illustrated embodiment of the invention;

FIG. 4B illustrates a side elevation view of the assembly of FIG. 4A; and

FIG. 4C illustrates a cutaway view of the assembly of FIG. 4C.

Before explaining the disclosed embodiment of the present invention in detail, it is to be understood that the invention is not limited in its application to the details of the particular arrangement shown since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof, as well as additional items.

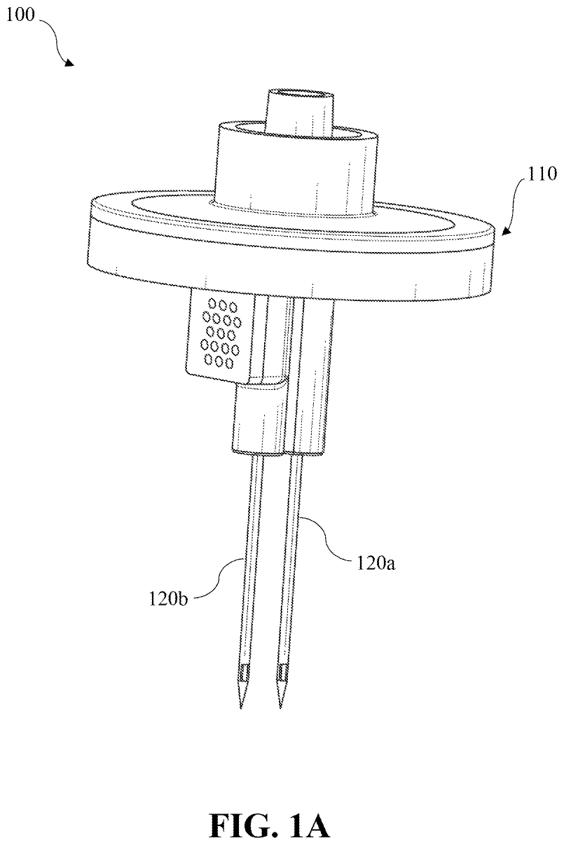

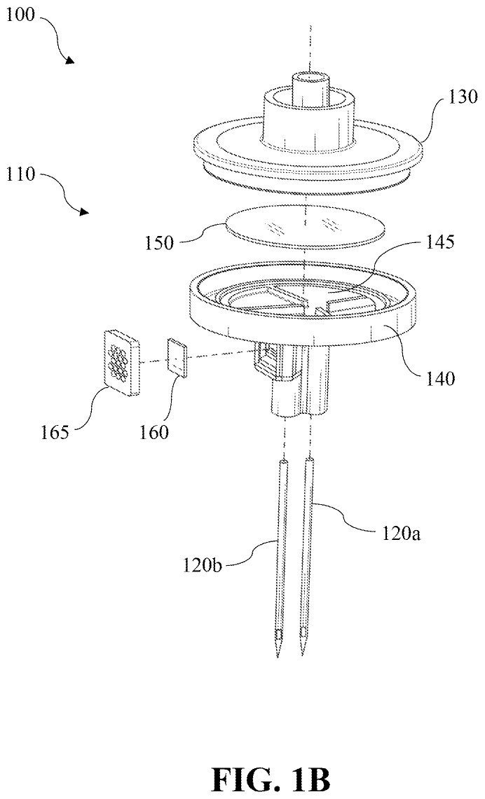

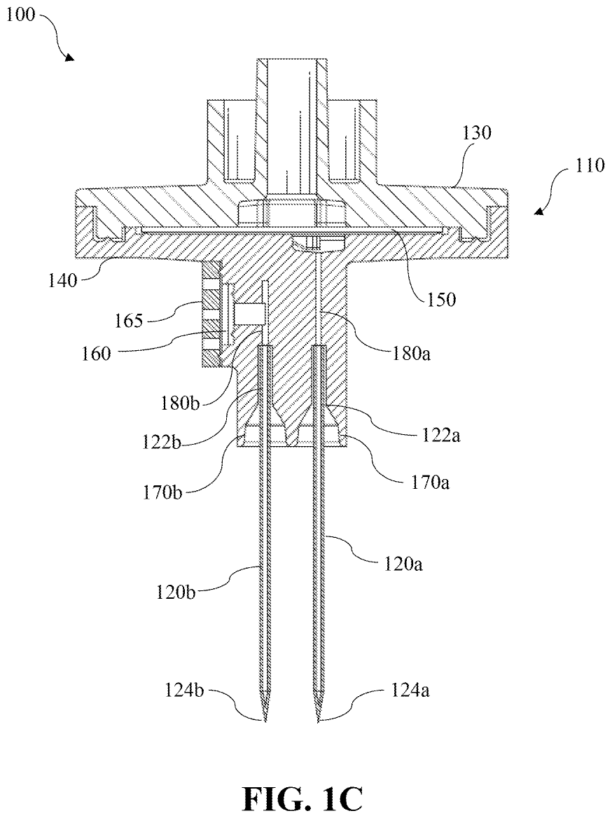

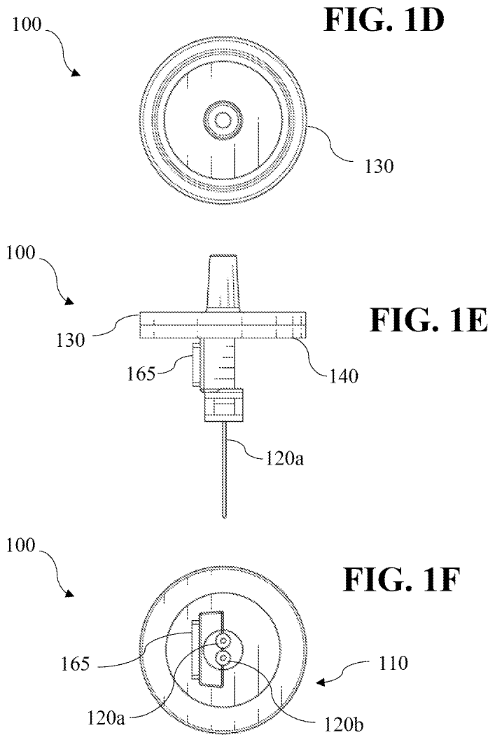

As shown in FIGS. 1A-1F, the embodiments of this disclosure include a dual needle assembly 100. The dual needle assembly 100 can comprise a housing 110, a first needle 120a, and a second needle 120b. The dual needle assembly 100 can serve the important purpose of transporting one or more fluids to and/or from a vial.

Each of the first and second needles 120a, 120b, can be constructed of stainless steel. For example, in a non-limiting embodiment, each of the first and second needles 120a, 120b can have a composition of X₅CrNi₁₈₋₁₀. Each of the first and second needles 120a, 120b, can have a cannula outside diameter of about 0.60 millimeters (mm) to about 70 mm and an inside diameter (i.e., a gauge) of about 0.30 mm to about 0.40 mm.

As shown best in FIGS. 1B and 1C, the housing 110 can comprise an upper portion 130 and a lower portion 140. Each of the upper portion 130 and the lower portion 140 can be constructed of a polymer. For example, in one non-limiting embodiment, the upper portion can be constructed of methyl methacrylate-acrylonitrile-butadiene-styrene (MABS) polymer such as Granulat Terlux® sold by INEOS Styrolution Group GMBH, Frankfurt, Germany. The lower portion 140 can be constructed from the same material as the upper portion 130. Alternatively, the lower portion 140 can be constructed of a different material as the upper portion 130.

The upper portion 130 can be attached to the lower portion 140 by a temporary, semi-permanent, or permanent attachment. In one non-limiting example, the upper portion 130 can be permanently attached to the lower portion 140 by ultrasonic welding. In another non-limiting example, the upper portion 130 can be a male slip-luer lock connector.

When the upper portion 130 and the lower portion 140 are coupled, a first sterility filter 150 can be positioned between a top surface 145 (shown in FIG. 1B) of the lower portion 140 and the upper portion 130. As such, the lower portion 140 can be a filter housing configured to house the first sterility filter 150, and the upper portion 130 can be a filter cap.

The first sterility filter 150 can be a fluid filter. The fluid filter can be a 0.1 micrometer (μm) to 0.3 μm hydrophilic filter. The fluid contact surface area of the first sterility filter 150 can be about 47 square centimeters (cm²) to about 49 cm². The fluid contact surface area of the first sterility filter 150 can be about 14 cm² to about 16 cm². Thus, the effective area of the first sterility filter 150 can be about 3 cm² to about 4 cm². The first sterility filter 150 can allow for a liquid flow rate of at least 10 milliliters per minute (mL/min).

The lower portion 140 can further comprise a second sterility filter 160. The second sterility filter can be positioned on a side of the lower portion 140. The second sterility filter 160 can be an air filter. The air filter can be a 0.5 μm to 1.5 μm hydrophobic filter. The second sterility filter 160 can be a rectangular shape having dimensions of about 1 cm by about 0.71 cm. The second sterility filter 160 can have an effective area of about 0.35 cm² to about 0.45 cm2. The second sterility filter 160 can allow for a gas flow rate of at least 10 mL/min.

A cover or vent 165 can be positioned over the second sterility filter 160 and coupled to the lower portion 140. The cover 165 can be constructed from the same material as the upper portion 130, the lower portion 140, or a different material. The cover 165 can comprise a plurality of openings that permit an air flow to flow to/from the second sterility filter.

Focusing on FIG. 1C, a first end 122a of the first needle 120a can be attached to the lower portion 140 of the housing 110. For example, the first end 122a of the first needle 120a can be attached to the lower portion 140 of the housing 110 via an adhesive. The adhesive can be applied at the first end 122a. The adhesive can be an ultra-violet (UV)-cured medical device adhesive. A second end 124a of the first needle 120a can extend from the lower portion 140 of the housing 110 and be tapered. For example, the tapered end can come to a point (i.e., a pencil-tip) or a bevel.

A third end 122b of the second needle 120b can be attached to the lower portion 140 of the housing 110. The third end 122b of the second needle 120b can be attached to the lower portion 140 of the housing 110 via the same adhesive used to attach the first needle 120a. In one embodiment, the second needle 120b can be positioned adjacent to the first needle 120a. A fourth end 124b of the second needle 120b can extend from the lower portion 140, and be tapered. For example, the tapered end of the second needle can come to a point (i.e., a pencil-tip) or a bevel. As shown, the first needle 120a and the second needle 120b can be the same length. This is not to be considered limiting. The first and second needles 120a, 120b can be the same or different lengths and preferably different lengths.

The first needle 120a can be configured to transport a first fluid, such as a liquid to and/or from a vial. The second needle 120b can be configured to transport a second fluid, such as a gas to and/or from the vial. Therefore, the first needle 120a has a first fluid path 180a. The first fluid path 180a permits the first fluid to flow through the cannula of the first needle 120a. The first fluid can be drawn from a vial and flow from the second end 124a up through the first needle 120a, out the first end 122a, through the first sterility filter 150, and out to a collection container, or from a supply container through the first sterility filter 150, into the first end 122a, down through the first needle 120a, and out through the second end 124a into the vial. As discussed above, the first fluid can be a liquid, and by adding or subtracting fluid from the vial, the pressure inside the vial can change. Therefore, to maintain an approximately constant desired pressure, the second needle 120b can be configured to transport a second fluid, such as air to and/or from the vial.

Therefore, the second needle 120b has a second fluid path 180b. The second fluid path 180b permits a second fluid to flow through the cannula of the second needle 120b. The second fluid can be drawn from the vial and flow from the fourth end 124b up through the second needle 120b through the second sterility filter 160, and out to a collection container or the atmosphere, or from a supply container or the atmosphere through the second sterility filter 160, down through the second needle 120b, and out through the fourth end 124b into the vial. As discussed above, the second fluid can be a gas, such as air. However, the air can contain contaminates that are undesirable inside the vial. Thus, the second sterility filter 160 can help ensure that gas flowing into/out of the vial is free of contamination.

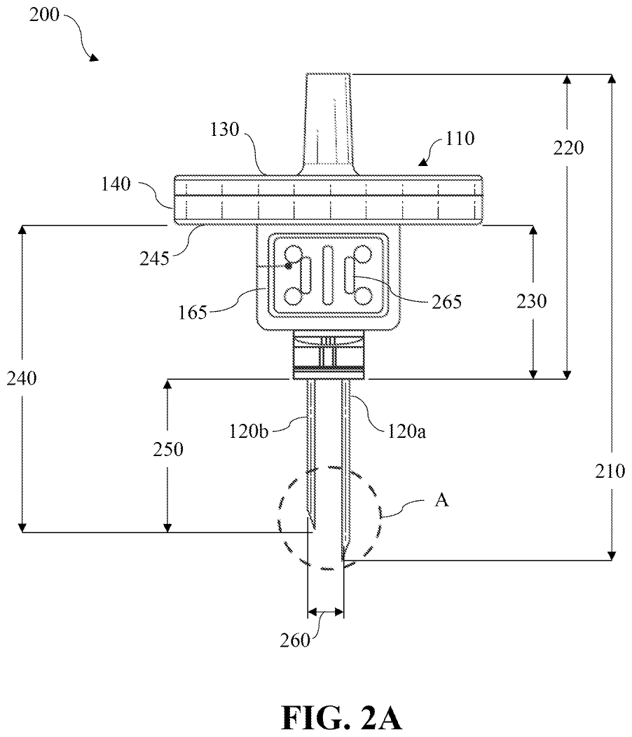

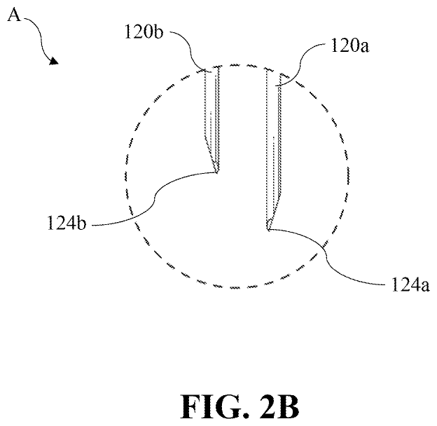

FIG. 2A-FIG. 2B are schematic and partial zoomed-in views, respectively, of a dual needle assembly 200 under an alternative embodiment where the first and second needles have different lengths.

The dual needle assembly 200 can have an overall length 210 of about 44 mm to about mm as measured from a top point of the upper portion 130 to the end of the first needle 120a. The housing 110 can have a length 220 of about 27 mm to about 29 mm. A length 230 measured from a bottom surface 245 of the lower portion 140 of the housing 110 to the end of the first needle 120a can have a length 230 of about 30 mm to about 22 mm.

A length 230 measured from a bottom surface 245 of the lower portion 140 of the housing 110 to the end of the second needle 120b can have a length 240 of about 27 to about 38 mm. The portion of the second needle 120b that extends from the lower portion 140 can have a length 250 of about 13 mm to about 14 mm. The first and second needles 120a, 120b can be spaced a distance 260 of about 3 mm to about 4 mm in from each other as measured from the center of the cannulas. The cover 165 can be attached to the side of the lower portion 140 by an adhesive. The cover 165 can comprise support ribs 265.

FIG. 2B shows a magnified view of the area A of FIG. 2A. As illustrated in FIG. 2B, the second end 124a of the first needle 120a, and the fourth end 124b of the second needle 120b can be tapered as described above. In embodiments where the ends are beveled, the beleved ends can point away from each other by about 180 degrees+/− about 45 degrees. By having the beveled ends point away from each other, there can be less cross-contamination between fluids transported through the first and second needles 120a, 120b.

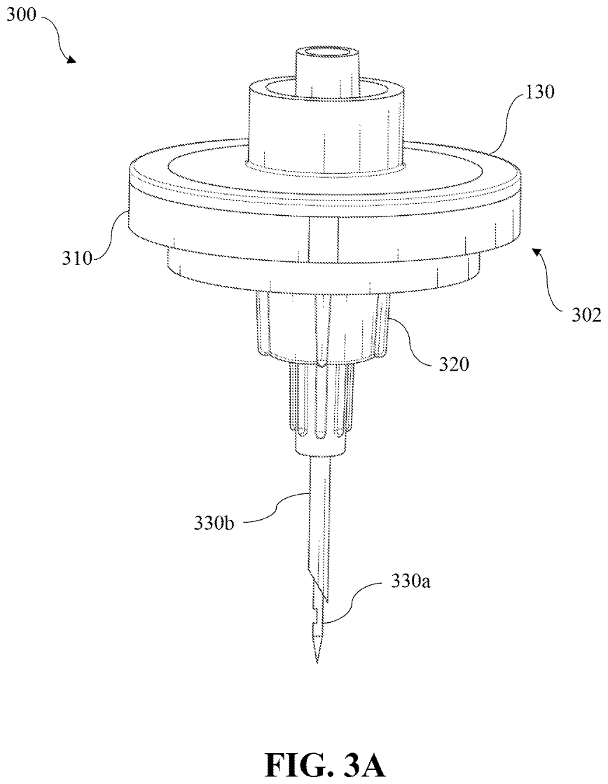

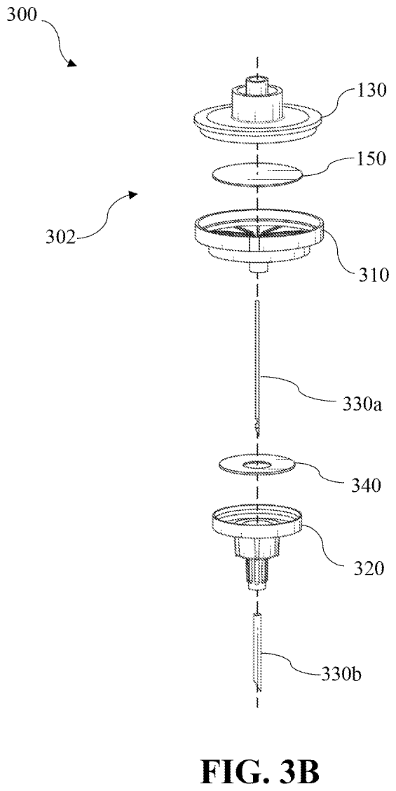

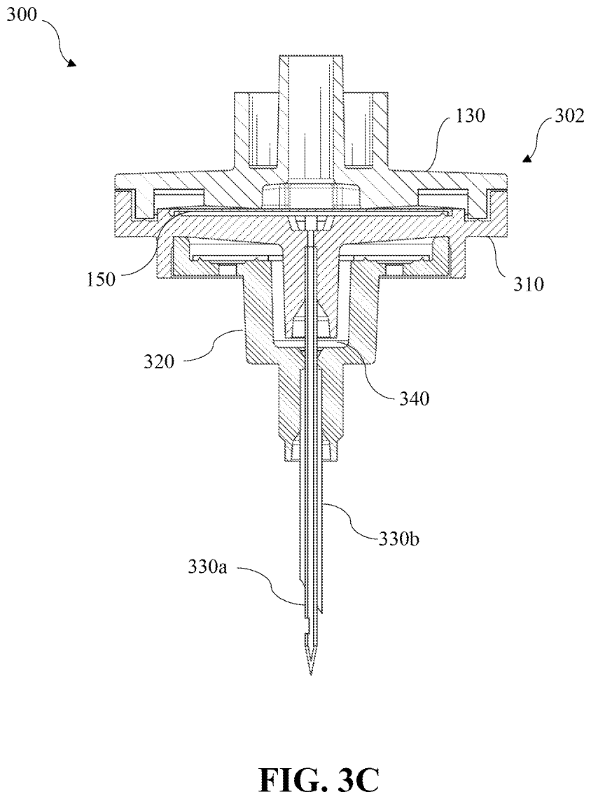

Now referring to FIGS. 3A-3C various views of a dual needle assembly 300 in accordance with an alternative embodiment are shown.

The dual needle assembly 300 is similar to the dual needle assemblies 100 of FIGS. 1A-1F and 200 of FIG. 2A-2B; however, the second needle surrounds the first one. As such, the housing can also have an alternative construction.

A housing 302 of the dual needle assembly 300 comprises the upper portion 130 (see FIGS. 1A-1F and 2A-2B), a first portion 310 of a lower housing, and a second portion 320 of the lower housing. The first portion 310, and the second portion 320 can be constructed from the same materials as the lower portion 140 of FIG. 1A-1F. The first portion 310 can house the first sterility filter 150 and can be coupled to the upper portion 130. The second portion 320 can house a second sterility filter 340. When the first portion 310 is coupled to the second portion 320, the second sterility filter 340 can be positioned between the first portion 310 and the second portion 320.

The second sterility filter 340 can be an air filter. The second sterility filter 340 can be similar to the second sterility filter 160 of FIG. 1A-1F; however, the second sterility filter 340 has an alternative shape here. The second sterility filter 340 can have a “donut” (toroidal) like shape (i.e., a circular shape with a center portion removed) to allow a first needle 330a to pass through the second sterility filter 340 without a flow path of the fluid being transported through the first needle 330a to come into contact with the second sterility filter 340.

The first needle 330a can be connected to the first portion 310. The first needle 330a can be the first needle 120a of FIG. 1A-FIG. 1C and FIG. 2A-FIG. 2B. A second needle 330b can be positioned around the first needle 330a. The second needle 330b can serve the same purpose as the second needle 120b of FIG. 1A-FIG. 1C and FIG. 2A-FIG. 2B. However, the second needle 330b can have a larger cannula opening, thereby permitting the first needle 330a to be positioned through the opening of the second needle 330b. The second needle 330b can be connected to the second portion 320 of the lower portion of the housing. As shown, the first needle 330a can have a greater length than the second needle 330b.

The first and second needles 330a, 330b can be connected to the first portion 310 and the second portion 320 of the lower housing using the same adhesive to connect the first and second needles 120a, 120b to the lower portion 140 of the housing 110 of FIG. 1A-FIG. 1C.

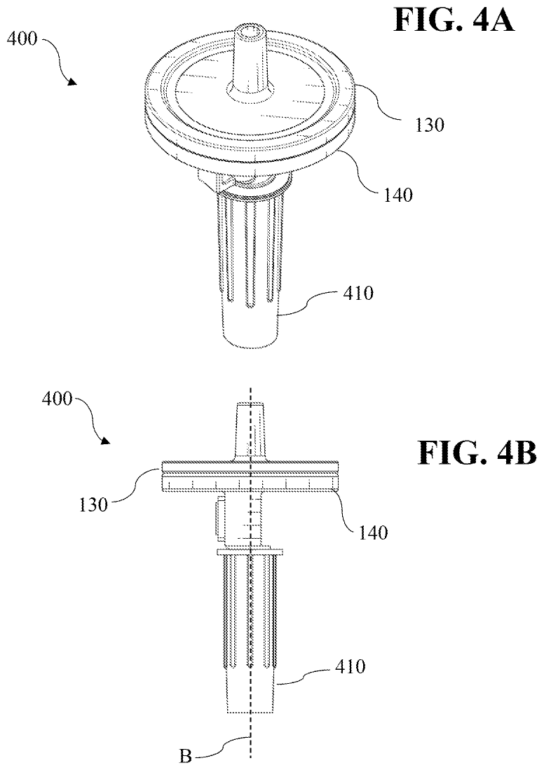

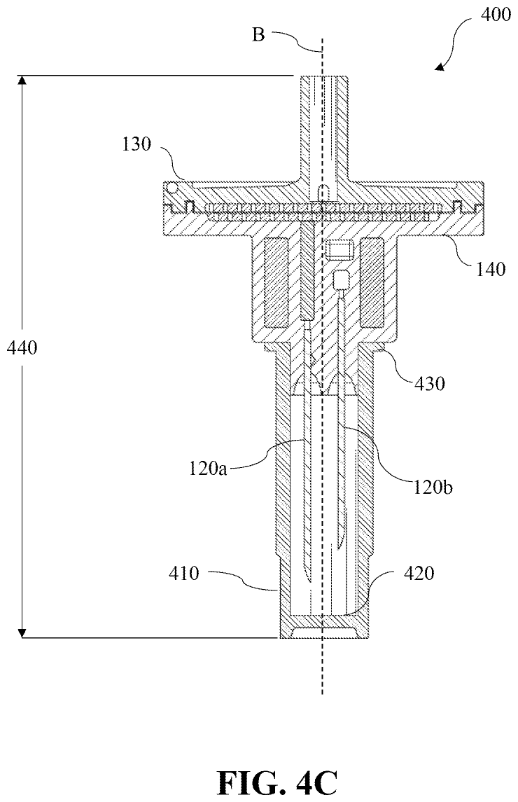

Turning now to FIGS. 4A-4D, various views of an assembly 400 comprising a dual needle assembly and a needle cover 410 are shown. The dual needle assembly can be the dual needle assembly 100 of FIGS. 1A-1F, the dual needle assembly 200 of FIGS. 2A-2B, the dual needle assembly 300 of FIGS. 3A-3C, or combinations thereof. For example, as shown, the assembly 400 includes the dual needle assembly 100 of FIGS. 1A-1F.

When the dual needle assembly 100 is not in use, it can be desirable to have the needle cover or guard 410 surrounding the first and second needles 120a, 120b. The needle cover 410 can protect the first and second needles 120a, 120b from physical damage and contaminants. The needle cover 410 can also provide protection for a user handling the dual needle assembly 100 by providing a physical barrier between the user and the first and second needles 120a, 120b, which can be sharp.

Thus, the needle cover 410 can be configured to surround the first and second needles 120a, 120b. However, it can be ideal to not have the first and second needles 120a, 120b touch a bottom surface 420 of the needle cover 410 because the needle cover can damage the first and second needles 120a, 120b. Thus, the dual needle assembly 100 can be in contact with or connected to a lip 430 of the needle cover 410. Further, at least some of the lower portion 140 can also be covered by the needle cover 410. The connection between the lower portion 140 and the needle cover 410 can be a tension fit, a threaded connection, a temporary adhesive, or any other connection known in the art.

When the dual needle assembly 100 is connected to the needle cover 410, the assembly 400 can have a total height 440 of about 48 millimeters to about 50 mm. As best illustrated in FIG. 4C showing a cutaway view, and FIG. 4D showing an exploded view down a center line B that bisects the assembly 400, the dual needle assembly 100 is centered with the needle cover 410. Thus, the first and second needles 120a, 120b preferably do not touch the sides of the needle cover 410. The needle cover 410 can be comprised of polypropylene or a similar polymer. However, by spacing the first and second needles 120a, 120b away from a wall of the needle cover 410, the first and second needles 120a, 120b can be protected from damage that might occur if they came into contact with the needle cover 410.

Specific embodiments of a dual needle assembly and needle guard have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

What is claimed is:

1. A dual needle assembly comprising:
a housing comprising:
a first sterility filter; and
a second sterility filter;
a first needle for transporting a first fluid comprising:
a first end coupled to the housing; and
a second end extending from the housing; and
a second needle for transporting a second fluid comprising:
a third end coupled to the housing; and
a fourth end extending from the housing,
wherein a first flow path of the liquid passes through the first sterility filter, and
wherein a second flow path of the stream of air passes through the second sterility filter.

2. The dual needle assembly of claim 1, wherein the first fluid is different than the second fluid.

3. The dual needle assembly of claim 1, wherein the first fluid is a liquid.

4. The dual needle assembly of claim 1, wherein the second fluid is a gas.

5. The dual needle assembly of claim 1, wherein the first sterility filter is a liquid filter, and wherein the second sterility filter is an air filter.

6. The dual needle assembly of claim 1, wherein the housing comprises:
an upper portion; and
a lower portion coupled to the upper portion,
wherein the first sterility filter is positioned between the upper portion and a first top surface of the lower portion, and
wherein the upper portion is a fluid filter cap.

7. The dual needle assembly of claim 3, wherein the second sterility filter is positioned on a side of the lower portion of the housing.

8. The dual needle assembly of claim 3, wherein the lower portion comprises:
a fluid filter housing;
an air filter housing; and
the second sterility filter is positioned between the fluid filter housing and a second top surface of the air filter housing.

9. The dual needle assembly of claim 1, wherein the first needle has a first gauge, and wherein the second needle has a second gauge equal to the first gauge.

10. The dual needle assembly of claim 1, wherein the first needle has a first gauge, and wherein the second needle has a second gauge different than the first gauge.

11. The dual needle assembly of claim 1, wherein the first needle is positioned adjacent to the second needle.

12. The dual needle assembly of claim 1, wherein the first needle is positioned through a center opening of the second needle.

13. The dual needle assembly of claim 1, wherein the first needle has a first length, and wherein the second needle has a second length equal to the first length.

14. The dual needle assembly of claim 1, wherein the first needle has a first length, and wherein the second needle has a second length different than the first length.

15. The dual needle assembly of claim 1, wherein the second end of the first needle is tapered, and wherein the fourth end of the second needle is tapered.

16. A dual needle assembly comprising:
a housing comprising
an upper portion; and
a lower portion coupled to the upper portion;
a first needle for transporting a first fluid extending from the housing;
a second needle for transporting a second fluid extending from the housing; and
a needle guard surrounding the first needle and the second needle,
wherein the needle guard contacts at least a portion of the housing.

17. The dual needle assembly of claim 16, wherein at least a portion of the housing is surrounded by the needle housing.

18. The dual needle assembly of claim 16, wherein the needle guard comprises a lip designed to connect to the lower portion of the housing.

19. The dual needle assembly of claim 16, wherein the housing comprises a first sterility filter designed to filter a first fluid transported through the first needle, and wherein the housing comprises a second sterility filter designed to filter a second fluid transported through the second needle.

20. The dual needle assembly of claim 16, wherein the first sterility filter is a liquid filter, and wherein the second sterility filter is an air filter.
